(19) United States
(12) Patent Application Publication
(10) Pub. No.: US 2002/0175252 A1
(43) Pub. Date: Nov. 28, 2002

(54) Transport caddy for pump and pail and method of using

(76) Inventor: Daniel J. House, Richland, WI (US)

Correspondence Address: SHERRILL LAW OFFICES, 4756 BANNING AVE, SUITE 212, WHITE BEAR LAKE, MN, 55110-3205, US

(21) Appl. No.: 10/133,196

(22) Filed: Apr. 26, 2002

Related U.S. Application Data
(60) Provisional application No. 60/286,700, filed on Apr. 26, 2001.

(51) Int. Cl. A47K 1/00; F16B 1/00

(52) U.S. Cl. 248/213.2; 248/304

(57) ABSTRACT

A transport caddy with a handgrip, a hook effective for retaining the handle of a pail, and a clamp effective for retaining a pump. The hook and the clamp extend in substantially opposite directions from the handgrip.

This application claims the benefit of U.S. Provisional Application No. 60/286,700, filed Apr. 26, 2001.

### FIELD OF THE INVENTION

The invention relates to devices used to connect multiple items for purposes of facilitating handling and transport of the items.

### BACKGROUND

A wide variety of tasks involves dispensing a pumpable material from a pail using a portable pump, which rests against a wall of the pail. One example is the dispensing of joint compound, commonly referenced as mud, from a standard 5-gallon pail using a hand operable mud pump. Such pump and pail combinations greatly simplify the dispensing of pumpable materials from a pail. However, transportation of a pump and pail combination around a job site can be very cumbersome as the pump changes the center of gravity of the pail to such an extent that the pail will tip and spill its contents unless the pump is grabbed along with the handle on the pail when lifting the pump and pail combination. A 5-gallon pail filled with a pumpable material, such as mud or grease, can weigh well in excess of 40 lbs., making it even more difficult to safely transport the pump and pail combination around a job site.

Accordingly, a substantial need exists for a simple and reliable device capable of facilitating transportation of a pump and pail combination around a job site with one hand.

### SUMMARY OF THE INVENTION

The invention includes (i) a transport caddy for use with a pump and a pail combination, (ii) an assembly of the transport caddy with a pump and pail combination, and (iii) a method of transporting a pump and pail combination using the transport caddy.

The transport caddy includes (i) a handgrip, (ii) a hook, and (iii) a clamp, wherein the hook and the clamp extend in substantially opposite directions from the handgrip.

The assembly includes (i) the transport caddy, (ii) a pail with a handle retained within the hook of the transport caddy, and (iii) a pump resting against the pail wall and retained within the clamp of the transport caddy.

The method includes the steps of (i) obtaining (a) the transport caddy, (b) a pail, and (c) a pump, (ii) resting the pump against the pail wall, (iii) securing the pump to the transport caddy by the clamp of the transport caddy, (iv) placing the pail handle within the hook of the transport caddy, (v) gripping the handgrip of the transport caddy, and (vi) lifting the pump and pail by lifting the handgrip.

### BRIEF DESCRIPTION OF THE DRAWINGS

FIG. 1 is a side view of one embodiment of the invention.

FIG. 2 is a side view of the invention shown in FIG. 1 attached to a pump and pail.

FIG. 3 is a side view of a second embodiment of the invention.

FIG. 4 is a side view of a third embodiment of the invention.

### DETAILED DESCRIPTION OF THE INVENTION INCLUDING A BEST MODE

Nomenclature

10 Transport Caddy

20 Handgrip

30 Hook

38 Channel Defined by the Hook

38d Channel Depth

39 Opening into the Channel defined by the Hook

40 Clamp

41 First Appendage of Clamp

41d Distal End of First Appendage

42 Second Appendage of Clamp

42d Distal End of Second Appendage

50 Shaft

50a First Longitudinal End of Shaft

50b Second Longitudinal End of Shaft

60 Machine Screw

61 Distal End of Machine Screw

100 Pump

110 Pump Housing

120 Bracket

200 Pail

210 Pail Wall

220 Pail Handle

Definitions

As utilized herein, the term “channel area,” means the cross-sectional aperture defined by a hook which, with the sides enclosed and the opening into the channel centered upward, could retain water.

As utilized herein, the term “channel depth,” means the longitudinal distance between the longitudinally lowest point of the channel to the distal end of the hook.

Construction

The transport caddy 10 includes a handgrip 20, a hook 30, and a clamp 40.

The handgrip 20 should be configured and arranged to allow a user (not shown) to comfortably grip the handgrip 20 with one hand and lift the transport caddy 10 while standing just laterally offset from the transport caddy 10. The handgrip 20 is preferably ergonomically designed, as to size, shape and material of construction, so as to allow a user to comfortably and securely transport loads in excess of 40 lbs.

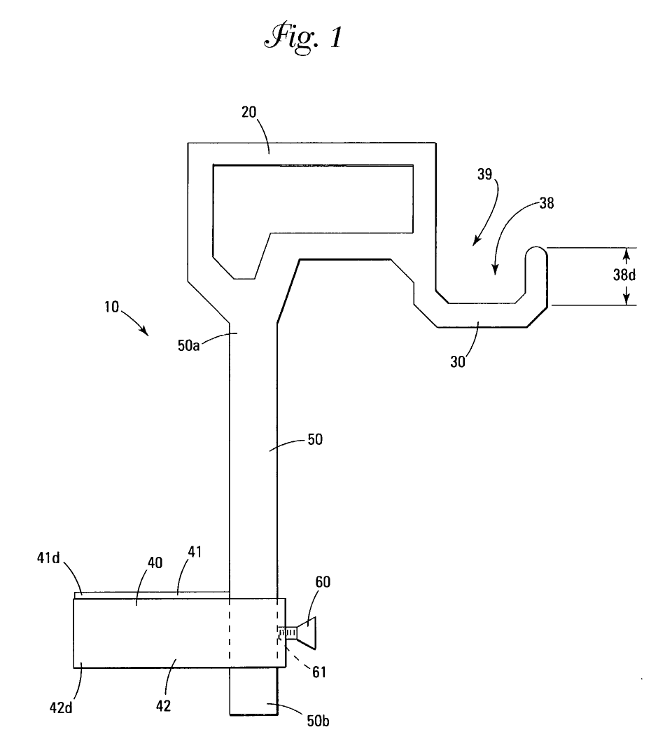

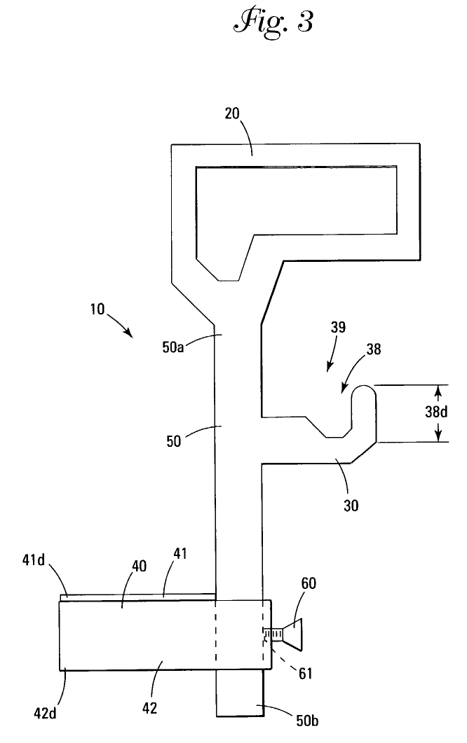

As shown in FIG. 1, the hook 30 is connected to and extends from the handgrip 20 in a first transverse direction and is configured and arranged to accept and retain a pail handle 220 in an upward position. Alternatively, as shown in FIG. 3, the hook 30 can be connected to and extend from the shaft 50.

The hook 30 will bear the brunt of the weight exerted by the pump 100, pail 200 and pumpable material (not shown) contained within the pail 200 during transportation, and should be constructed accordingly.

The hook 30 defines an upwardly open channel 38 for retaining the pail handle 220. For ease of use, the channel 38 preferably has an area of about 0.5 to 2 in², most preferably about 0.8 to 1.5 in². A channel 38 of less than about 0.5 in² does not securely retain the pail handle 220 during normal use, while a channel 38 of greater than about 2 in² increases the size of the transport caddy 10 without any corresponding increase in benefits.

The channel 38 preferably has a depth 38d of about 0.5 to 1 inch. A channel depth 38d of less than about 0.5 inch does not securely retain the pail handle 220 during normal use, while a channel depth 38d of greater than about 1 inch complicates insertion and removal of the pail handle 220 into the channel 38 without a corresponding increase in retention of the pail handle 220 within the channel 38 during normal use.

The opening 39 into the channel 38 is preferably about 0.8 to 2 inches. The pail handle 220 can be difficult to position within the hook 30 when the opening 39 is less than about 0.8 inches, while an opening 39 of greater than about 2 inches increases the size of the transport caddy 10 without any corresponding increase in benefits.

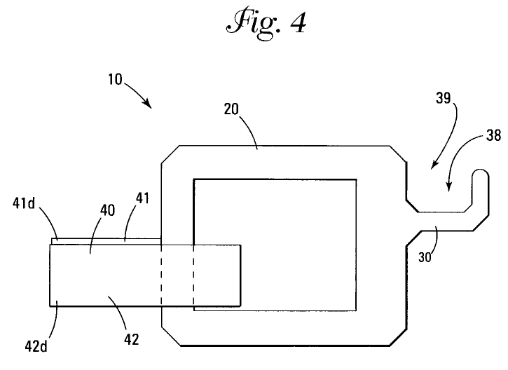

As shown in FIG. 1, the clamp 40 is connected to and extends from the shaft 50 in a second transverse direction which is opposed to the first transverse direction in which the hook 30 extends. Alternatively, as shown in FIG. 4, the clamp 40 can be connected to and extend from the handgrip 20. The clamp 40 is configured and arranged to accept and retain a pump 100.

The clamp 40 need not be actively involved in lifting the pump 100. The pump 100 rests against the bottom (not shown) and/or the upper edge (unnumbered) of the wall 210 of the pail 200 and will therefore be lifted along with the pail 200. The clamp 40 preferably allows the pump 100 to longitudinally slide within the clamp 40 so as to allow the pump 100 to rest against the bottom (not shown) and/or the upper edge of the wall 210 of the pail 200. When the clamp 40 is not actively involved in lifting the pump 100, the clamp 40 need only hold the pump 100 in position against the tendency of the pail 200 to tip towards the pump 100. This “rearward” force exerted by off-centered nature of the pump 100 is substantially less than the downward force exerted upon the hook 30 by the pump 100, pail 200 and pumpable material within the pail 200. Hence, only a modest clamping force is necessary to hold the pump 100 in position.

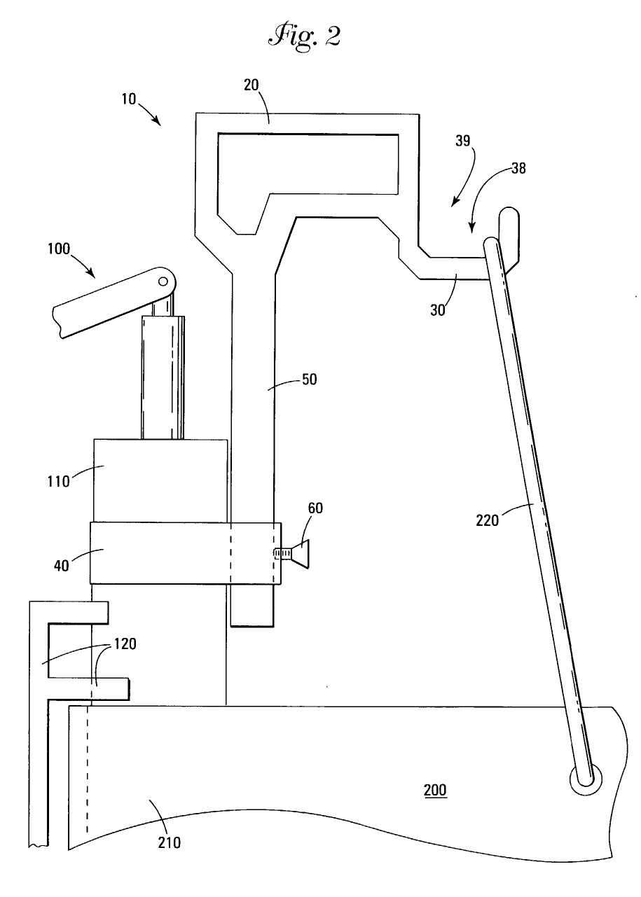

Any of the wide variety of clamping devices and mechanisms may be usefully employed. As shown in FIGS. 1-4, a suitable clamp 40 includes laterally opposed appendages 41 and 42 with distal ends 41d and 42d capable of lateral expansion for allowing insertion of the pump 100 between the appendages 41 and 42. The appendages 41 and 42 may be biased towards each other so as to engage a pump 100 positioned between the appendage 41 and 42 by any suitable biasing means. Exemplary biasing means include compression springs, expansion springs, and leaf springs. A leaf spring can be achieved by constructing the appendages 41 and 42 from an elastic material and undersizing the opening (not shown) between the appendages 41 and 42 so as to cause the appendages 41 and 42 to expand upon insertion of the pump 100 between the appendages 41 and 42. The elasticity of the appendages 41 and 42 causes the appendages 41 and 42 to seek a return to their original position, thereby pinching the pump 100 between the appendages 41 and 42.

In order to accommodate differently sized pumps 100 and pails 200, the clamp 40 is preferably secured to the handgrip 20 or the shaft 50 by a means which allows the clamp 40 to be longitudinally slid along the handgrip 20 or the shaft 50 and thereby change the longitudinal distance between the hook 30 and the clamp 40. Generally, a wide variety of pumps 100 and pails 200 can be accommodated by allowing the clamp 40 to slid a longitudinal distance of between about 1 to 10 inches.

Wide varieties of releasable fasteners suitable for use in the invention are well known to those skilled in the art. One example of such a releasable fastener, shown in FIGS. 1-3, is a hand-tightenable bolt or machine screw 60. The machine screw 60 is threadably engaged within a bore (unnumbered) through the clamp 40 for allowing the distal end 61 of the machine screw 60 to contact and frictionally engage the shaft 50 when tightened. The machine screw 60 allows the clamp 40 to be longitudinally repositioned by simply loosening the machine screw 60 from engagement with the shaft 50, repositioning the clamp 40, and then retightening the machine screw 60 into frictional engagement with the shaft 50.

As shown in FIG. 1, the shaft 50 is connected to the handgrip 20 at a first end 50a and extends from the handle 20 in a first longitudinal direction with a free distal end 50b. The shaft 50 allows the hook 30 and clamp 40 to be longitudinally spaced from the handgrip 20 and each other. This is often necessary and appropriate as the hook 30 and the clamp 40 must contact the pail handle 220 and the pump 100 at different longitudinal positions respectively.

The shaft 50 preferably has a length of about 3 to 20 inches, with a length of about 4 to 8 inches typically sufficient to provide the desired benefits.

It is also desired to longitudinally space the handgrip 20 above the hook 30 and the clamp 40 (i.e., spaced in the second longitudinal direction) in order to provide easy access to the handgrip 20. In addition, the pump 100 and pail 200 combination are more stable when transported using the transport caddy 10 when the handgrip 20 is above the contact point between the hook 30 and the pail handle 220 so that the pump 100 and pail 200 are pulled up by the transport caddy 10 rather than pushed up.

The transport caddy 10 should be constructed from a material with sufficient structural integrity to survive repeated lifting of loads of up to about 80 lbs. The material should also be easily cleaned. Suitable materials include, by way of example only, high impact plastics and metals.

Use

The transport caddy 10 is attached to a pump 100 and pail 200 combination after the pail 200 has been filled with a pumpable material and the pump 100 submerged into the pumpable material with the bracket 120 resting over a wall 210 of the pail 200 by (i) securing the transport caddy 10 to the pump 100 by inserting the pump 100, preferably the pump housing 110, within the clamp 40, and (ii) placing the pail handle 220 within the hook 30. Once attached, the transport caddy 10 can be used to transport the pump 100 and pail 200 combination, including the contents of the pail 200, by simply gripping the handgrip 20 of the transport caddy 10 with one hand and lifting.

When necessary, the longitudinal distance between the hook 30 and the clamp 40 can be adjusted to fit the dimensions of a specific pump 100 and pail 200 combination by loosening the machine screw 60, sliding the clamp 40 along the shaft 50 to the desired location, and then retightening the machine screw 60.

The transport caddy 10 can be quickly detached by applying downward pressure upon the handgrip 20 while pulling up on the pail handle 220 to remove the pail handle 220 from the hook 30 and then pulling forward on the transport caddy 10 while holding the pump 100 steady until the clamp 40 releases the pump 100. The transport caddy 10 can remain attached to the pump 100 when the pump 100 is transferred from an empty pail 200 to a full pail 200.

I claim:

1. A transport caddy for use with a pump and a pail combination, comprising a handgrip, a hook, and a clamp wherein the hook and the clamp extend in substantially opposite directions.

2. The transport caddy of claim 1 further comprising a shaft longitudinally extending from the handgrip in a first longitudinal direction and wherein the hook and the clamp are longitudinally offset from the handgrip and connected to the shaft.

3. The transport caddy of claim 1 wherein the hook forms a channel which is longitudinally open.

4. The transport caddy of claim 1 wherein the clamp is configured and arranged to clamp onto a mud pump housing.

5. The transport caddy of claim 1 further comprising a shaft longitudinally extending from the handgrip in a first longitudinal direction and wherein the clamp is longitudinally offset from the handgrip and connected to the shaft.

6. The transport caddy of claim 5 wherein the hook forms a channel, which is longitudinally open in a second longitudinal direction which is opposite the first longitudinal direction.

7. The transport caddy of claim 5 wherein (a) the hook defines a channel with (1) an opening of about 0.8 to 2 inches, and (2) a depth of about 0.5 to 1 inch; and (b) the shaft has a longitudinal length of about 2 to 10 inches.

8. The transport caddy of claim 5 wherein the clamp slidably engages the shaft so as to permit longitudinal repositioning of the clamp along the shaft.

9. The transport caddy of claim 8 wherein the means for longitudinally repositioning the clamp is a hand-operable means for longitudinally repositioning the clamp.

10. An assembly, comprising:
(a) a transport caddy comprising a handgrip, a hook, and a clamp with the hook and the clamp extending in substantially opposite directions from the handgrip;
(b) a pail having a wall and a handle connected to the pail and retained within the hook; and
(c) a pump resting against the pail wall and retained within the clamp.

11. The assembly of claim 10 wherein the transport caddy further comprises a shaft longitudinally extending from the handgrip in a first longitudinal direction and wherein the hook and the clamp are longitudinally offset from the handgrip and connected to the shaft.

12. The assembly of claim 10 wherein the hook forms a channel which is longitudinally open.

13. The assembly of claim 10 wherein the transport caddy further comprises a shaft longitudinally extending from the handgrip in a first longitudinal direction and wherein the clamp is longitudinally offset from the handgrip and connected to the shaft.

14. The assembly of claim 13 wherein the clamp slidably engages the shaft so as to permit longitudinal repositioning of the clamp along the shaft.

15. The assembly of claim 13 wherein the hook forms a channel, which is longitudinally open in a second longitudinal direction which is opposite the first longitudinal direction.

16. The assembly of claim 13 wherein (a) the hook defines a channel with (1) an opening of about 0.8 to 2 inches, and (2) a depth of about 0.5 to 1 inch; and (b) the shaft has a longitudinal length of about 2 to 10 inches.

17. A method of transporting a pump and pail combination, comprising:
(a) obtaining:
(1) a transport caddy comprising a handgrip, a hook and a clamp with the hook and the clamp extending in substantially opposite directions from the handgrip,
(2) a pail having a wall and a handle connected to the pail, and
(3) a pump,
(b) resting the pump against the pail wall;
(c) securing the pump to the transport caddy by the clamp;
(d) placing the pail handle within the hook;
(e) gripping the handgrip; and
(f) lifting the pump and pail by lifting the handgrip.

18. The method of claim 17 wherein the pail has a capacity of between about 3 and 10 gallons.

19. The method of claim 17 wherein the pump is a manually operable pump and includes a bracket for securing the wall of the pail between the bracket and the pump.

20. The method of claim 17 wherein the transport caddy further comprises a shaft longitudinally extending from the handgrip in a first longitudinal direction and wherein the clamp is longitudinally offset from the handgrip and connected to the shaft.

21. The method of claim 20 wherein the hook forms a channel, which is longitudinally open in a second longitudinal direction which is opposite the first longitudinal direction.

22. The method of claim 20 wherein (a) the hook defines a channel with (1) an opening of about 0.8 to 2 inches, and (2) a depth of about 0.5 to 1 inch; and (b) the shaft has a longitudinal length of about 2 to 10 inches.

23. The method of claim 17 wherein the transport caddy further comprises a shaft longitudinally extending from the handgrip in a first longitudinal direction and wherein the hook and the clamp are longitudinally offset from the handgrip and connected to the shaft.

24. The method of claim 23 wherein the hook forms a channel, which is longitudinally open in a second longitudinal direction which is opposite the first longitudinal direction.

25. The method of claim 20 wherein the clamp slidably engages the shaft so as to permit longitudinal repositioning of the clamp along the shaft.

26. The method of claim 25 wherein the means for longitudinally repositioning the clamp is a hand-operable means for longitudinally repositioning the clamp.

27. The method of claim 25 wherein the clamp is slidable along the shaft for a longitudinal distance of between about 1 to 10 inches.
